(19) United States
(12) Patent Application Publication
(10) Pub. No.: US 2024/0255827 A1
(43) Pub. Date: Aug. 1, 2024

(54) Optical Waveguide Device, and Optical Modulation Device and Optical Transmission Apparatus Using Same

(71) Applicant: SUMITOMO OSAKA CEMENT CO., LTD., Tokyo (JP)

(72) Inventors: Yu KATAOKA, Tokyo (JP); Shotaro HIRATA, Tokyo (JP); Yumi MURATA, Tokyo (JP)

(73) Assignee: SUMITOMO OSAKA CEMENT CO., LTD., Tokyo (JP)

(21) Appl. No.: 18/390,725

(22) Filed: Dec. 20, 2023

(30) Foreign Application Priority Data
Jan. 30, 2023 (JP) 2023-011975

(51) Int. Cl. G02F 1/225; G02F 1/21

(52) U.S. Cl. CPC G02F 1/225; G02F 1/212

(57) ABSTRACT

An optical waveguide device including an optical waveguide formed on a substrate is provided, in which a directional coupler is disposed in a part of the optical waveguide, the directional coupler includes one center waveguide and two side waveguides disposed to interpose the center waveguide between the side waveguides, the side waveguides are disposed to come close to the center waveguide from a position where the side waveguides are separated from the center waveguide and then to be separated again from the center waveguide in a traveling direction of a light wave, and the center waveguide and the side waveguides are not in contact with each other.

### CROSS-REFERENCE TO RELATED APPLICATION

This application claims the benefit of Japanese Patent Application No. 2023-011975 filed Jan. 30, 2023, the disclosure of which is herein incorporated by reference in its entirety.

### BACKGROUND OF THE INVENTION

### Field of the Invention

The present invention relates to an optical waveguide device, and an optical modulation device and an optical transmission apparatus using the same, and particularly to an optical waveguide device including an optical waveguide formed on a substrate, in which a directional coupler is disposed in a part of the optical waveguide.

### Description of Related Art

In the field of optical communication and in the field of optical measurement, an optical waveguide device such as an optical modulator including an optical waveguide formed on a substrate has been widely used. In recent years, in the optical modulator that is included in a transmitter incorporated in an optical transmission and reception apparatus, it has been required to miniaturize the optical waveguide device constituting the optical modulator in order to fulfill requirements of size reduction and low power consumption.

In the optical waveguide used in the optical waveguide device, a branching part in which a light wave branches or a Y-junction in which a light wave is combined is formed, as in a Mach-Zehnder type optical waveguide. For example, as illustrated in FIG. 1 to FIG. 4, various branching parts have been suggested. FIG. 1 is a Y-branched waveguide (Y) and illustrates a structure in which one input waveguide 11 is divided into two branched waveguides 13 and 14. In addition, FIGS. 2 and 3 illustrate use of multi-mode interference (MMI) waveguides. FIG. 2 illustrates a shape of one input waveguide (11) input into an MMI part (M1) and two output waveguides (13, 14), which is also referred to as “MMI (1×2)”. In addition, FIG. 3 illustrates a shape of two input waveguides (11, 12) input into an MMI part (M2) and two output waveguides (13, 14), which is also referred to as “MMI (2×2)”.

Furthermore, as illustrated in FIG. 4, a directional coupler (light waves branch or are combined in a part C1) using two waveguides (11 (13) and 12 (14)) has also been suggested.

However, as illustrated in FIG. 5, the Y-branched waveguide in FIG. 1 inevitably has radiated light R1 from the Y-branching part because of its structure. In addition, this phenomenon is more noticeable in a case where refractive index contrast between a core and a clad is increased because of the miniaturization. Furthermore, the radiated light R1 is unintentionally recoupled to signal light that propagates through the optical waveguide in a rear stage. Consequently, optical power and a phase of the signal light are disturbed, and this adversely affects various characteristics including an ON/OFF extinction ratio of the optical modulator.

In addition, the MMI waveguide or the directional coupler has wavelength dependence of a transmission loss (loss) and a branch ratio because of its operation principle. Particularly, the branch ratio has a significant adverse effect on the ON/OFF extinction ratio which is particularly important for the optical modulator. Thus, it is required to suppress such an issue in order to widen a used wavelength. Decreasing a device size is effective for reducing the wavelength dependence. However, in the case of MMI, as illustrated by a dotted line frame MC in FIG. 6, a part of the light wave propagating through one waveguide 11 is also transferred to the other waveguide 12 in a part where the waveguides 11 and 12 to be connected are close to each other, and so-called mode coupling occurs. Consequently, since the branch ratio and the optical loss deteriorate, a clearance between the waveguides 11 and 12 is constrained, and it is difficult to achieve size reduction for 100 μm or lower.

Furthermore, in Japanese Laid-open Patent Publication No. 2000-180646, it is suggested to improve the directional coupler to achieve reduction of the loss and the wavelength dependence by forming a tip end of the optical waveguide constituting the coupler to have a tapered shape as illustrated by a dotted line frame TP in FIG. 7. However, even in the case of FIG. 7, it is difficult to completely prevent radiation of light from a part where the waveguide 11 stops at the center. In addition, the narrow tapered shape of the tip end is likely to cause a formation defect under constraints such as the minimum linewidth of lithography, and this makes a manufacturing process more difficult.

### SUMMARY OF THE INVENTION

An object to be addressed by the present invention is to address the above issue and to provide an optical waveguide device that suppresses an optical loss of a light wave in a branching part and a Y-junction of an optical waveguide and that reduces deterioration of the optical loss and a branch ratio caused by wavelength dependence and leakage of an unnecessary light beam and furthermore, a level of difficulty in processing. Furthermore, an optical modulation device and an optical transmission apparatus using the optical waveguide device are provided.

In order to address the object, an optical waveguide device, an optical modulation device, and an optical transmission apparatus of the present invention have the following technical features.
(1) An optical waveguide device including an optical waveguide formed on a substrate is provided, in which a directional coupler is disposed in a part of the optical waveguide, the directional coupler includes one center waveguide and two side waveguides disposed to interpose the center waveguide between the side waveguides, the side waveguides are disposed to come close to the center waveguide from a position where the side waveguides are separated from the center waveguide and then to be separated again from the center waveguide in a traveling direction of a light wave, and the center waveguide and the side waveguides are not in contact with each other.
(2) In the optical waveguide device according to (1), a distance between the center waveguide and the side waveguides before coming close to the center waveguide and a distance between the center waveguide and the side waveguides after being separated from the center waveguide may be set to be twice or more of a mode diameter of a light wave propagating through the optical waveguide.
(3) In the optical waveguide device according to (1), an intensity of optical confinement of the optical waveguide in any of the center waveguide or the side waveguides may be weaker in a state where the center waveguide and the side waveguides are close to each other than in a state where the center waveguide and the side waveguides are separated from each other.
(4) In the optical waveguide device according to (1), the directional coupler may function as a branching waveguide that introduces a light wave from one side of the center waveguide and that derives the light wave branching from the two side waveguides positioned on the other side of the center waveguide.
(5) In the optical waveguide device according to (4), an unnecessary light beam removing unit that causes a light wave propagating through the center waveguide to be absorbed or to be radiated outside the optical waveguide device may be provided on an output side of the directional coupler.
(6) In the optical waveguide device according to (1), the directional coupler may function as a combining waveguide that introduces two light waves into each side waveguide from the one side of the two side waveguides and that derives a light wave into which the two light waves are combined from the center waveguide positioned on the other side of the side waveguides.
(7) In the optical waveguide device according to (6), an unnecessary light beam removing unit that causes a light wave propagating through the side waveguides to be absorbed or to be radiated outside the optical waveguide device may be provided on an output side of the directional coupler.
(8) In the optical waveguide device according to (6), a guide unit that guides at least a part of a light wave propagating through the side waveguides to a photo detection unit may be provided on an output side of the directional coupler.
(9) In the optical waveguide device according to (1), the optical waveguide may include a Mach-Zehnder type optical waveguide, and the directional coupler may be incorporated in at least one of a branching part or a Y-junction of the Mach-Zehnder type optical waveguide.
(10) An optical modulation device includes the optical waveguide device according to (1), a case accommodating the optical waveguide device, and an optical fiber through which a light wave is input into the optical waveguide or output from the optical waveguide.
(11) In the optical modulation device according to (10), the optical waveguide device may include a modulation electrode for modulating a light wave propagating through the optical waveguide, and an electronic circuit that amplifies a modulation signal to be input into the modulation electrode of the optical waveguide device may be provided inside the case.
(12) An optical transmission apparatus includes the optical modulation device according to (10), and an electronic circuit that outputs a modulation signal causing the optical modulation device to perform a modulation operation.

In the present invention, an optical waveguide device including an optical waveguide formed on a substrate is provided, in which a directional coupler is disposed in a part of the optical waveguide, the directional coupler includes one center waveguide and two side waveguides disposed to interpose the center waveguide between the side waveguides, the side waveguides are disposed to come close to the center waveguide from a position where the side waveguides are separated from the center waveguide and then to be separated again from the center waveguide in a traveling direction of a light wave, and the center waveguide and the side waveguides are not in contact with each other. Thus, a structure of the optical waveguide is simplified, a level of difficulty in processing is low, and an optical loss of the light wave can also be suppressed. Furthermore, the optical waveguide device that is also improved with respect to wavelength dependence can be provided. In addition, the optical modulation device and the optical transmission apparatus having the same excellent characteristics can be provided using the optical waveguide device.

### BRIEF DESCRIPTION OF THE DRAWINGS

FIG. 1 is a diagram illustrating an example of a Y-branched waveguide.

FIG. 2 is a diagram illustrating an example of an MMI waveguide (one input waveguide and two output waveguides; MMI (1×2)).

FIG. 3 is a diagram illustrating an example of an MMI waveguide (two input waveguides and two output waveguides; MMI (2×2)).

FIG. 4 is a diagram illustrating an example of a directional coupler based on two waveguides.

FIG. 5 is a diagram for describing radiated light R1 of the Y-branched waveguide.

FIG. 6 is a diagram for describing mode coupling of input light L1 of the MMI waveguide.

FIG. 7 is a diagram for describing an example of the directional coupler illustrated in Japanese Laid-open Patent Publication No. 2000-180646.

FIG. 8 is a diagram for describing a branching part of an optical waveguide used in an optical waveguide device of the present invention.

FIG. 9 is a diagram for describing a Y-junction of the optical waveguide used in the optical waveguide device of the present invention.

FIG. 10 is a diagram for describing an example of a Mach-Zehnder type optical waveguide of the optical waveguide device of the present invention.

FIG. 11 is a diagram illustrating a shape of a tip end of a waveguide as an example of an unnecessary light beam removing unit of a center waveguide in a directional coupler used in the present invention.

FIG. 12 is a diagram illustrating an example in which a reflective member is disposed at the tip end of the waveguide as an example of the unnecessary light beam removing unit of the center waveguide in the directional coupler used in the present invention.

FIG. 13 is a diagram illustrating an example in which an optical absorption member (an electrode member such as a signal electrode) is disposed in a part of the waveguide as an example of the unnecessary light beam removing unit of the center waveguide in the directional coupler used in the present invention.

FIG. 14 is a diagram for describing positions indicating each cross section shape of FIG. 15 to FIG. 18.

FIG. 15 is a cross sectional view taken along dotted lines A, D, and F in FIG. 14.

FIG. 16 is a cross sectional view taken along dotted line B in FIG. 14.

FIG. 17 is a cross sectional view taken along dotted line C in FIG. 14.

FIG. 18 is a cross sectional view taken along dotted line E in FIG. 14.

FIG. 19 is a diagram illustrating an example in which a photo detection unit is disposed outside a substrate of the optical waveguide device.

FIG. 20 is a diagram illustrating an example in which the photo detection unit is disposed on the substrate of the optical waveguide device.

FIG. 21 is a diagram for describing an example in which a plurality of Mach-Zehnder type optical waveguides are disposed parallel to each other as the optical waveguide used in the optical waveguide device.

FIG. 22 is a diagram for describing an example in which two Mach-Zehnder type optical waveguides are disposed in a nested form as the optical waveguide used in the optical waveguide device.

FIG. 23 is a diagram illustrating an optical transmission apparatus according to the present invention.

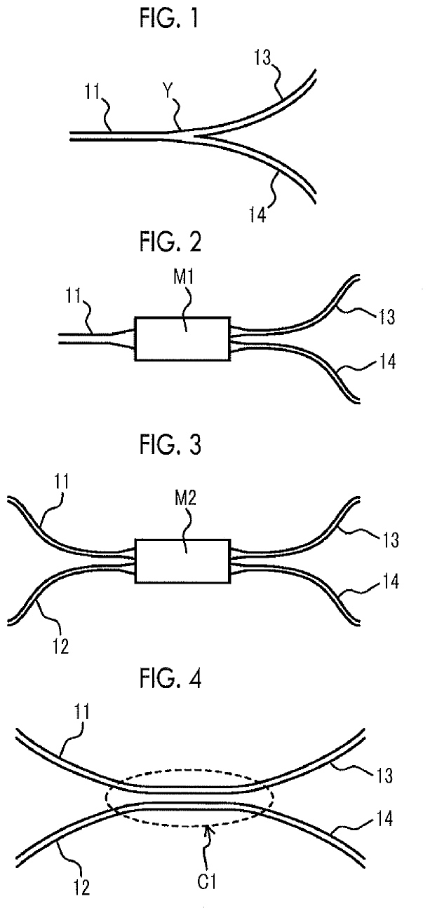

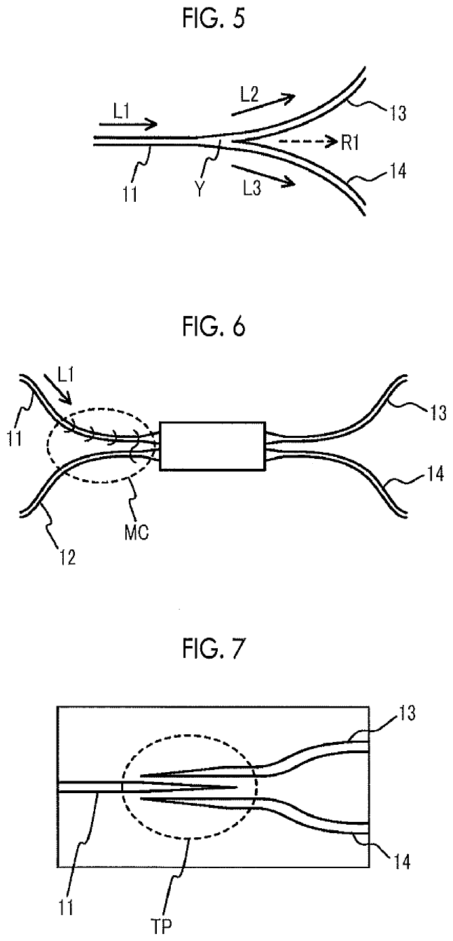

### DETAILED DESCRIPTION OF THE INVENTION

Hereinafter, the present invention will be described in detail using preferred examples.

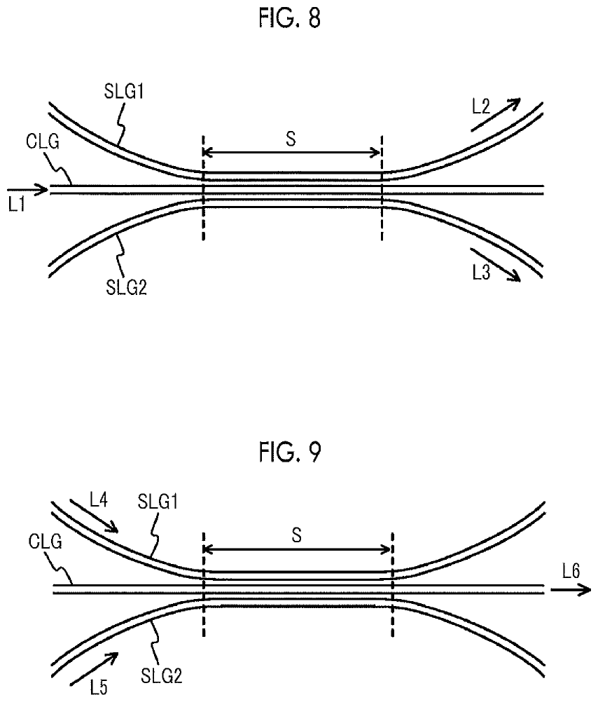

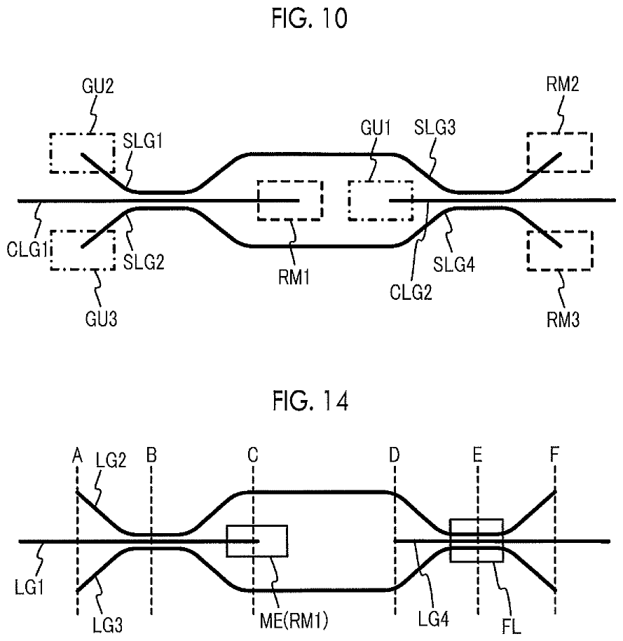

As illustrated in FIG. 8 and FIG. 9, in the present invention, an optical waveguide device including an optical waveguide formed on a substrate is provided, in which a directional coupler is disposed in a part of the optical waveguide, the directional coupler includes one center waveguide CLG and two side waveguides (SLG1, SLG2) disposed to interpose the center waveguide between the side waveguides, the side waveguides are disposed to come close to the center waveguide from a position where the side waveguides are separated from the center waveguide and then to be separated again from the center waveguide in a traveling direction of a light wave, and the center waveguide and the side waveguides are not in contact with each other.

As illustrated in FIGS. 8 and 9, the center waveguide CLG and the side waveguides (SLG1 and SLG2) are configured to have a continuous shape within a range constituting the directional coupler. Thus, a directional coupler having a significantly low loss can be implemented. In addition, since three optical waveguides are simply disposed, a level of difficulty in processing can also be set to be low.

As the substrate used in the optical waveguide device, any substrate of a material with which the optical waveguide is formed on a surface of the substrate can be used. Specifically, as the substrate having an electro-optic effect, a substrate of lithium niobate (LN), lithium tantalate (LT), lead lanthanum zirconate titanate (PLZT), or the like or a base material obtained by doping these substrate materials with MgO or the like can be used. In addition, a film of a material of LN or the like can be formed on a support substrate of Si, glass, sapphire or the like directly or through an intermediate layer using vapor-phase growth. In addition, a substrate obtained by joining the substrate having the electro-optic effect to another substrate and then processing the electro-optical substrate into a thin film can also be used. Furthermore, a semiconductor substrate, a substrate of an organic material such as EO polymer, and a quartz substrate used in a PLC can also be used. Different types of semiconductor films may be grown on the semiconductor substrate.

As a method of forming the optical waveguide, a part having a high refractive index can be locally formed to be used as the optical waveguide using a method of thermally diffusing Ti or the like in the LN substrate, a proton exchange method, or the like. In addition, a part of the substrate corresponding to the optical waveguide can be formed to have a protruding shape to be used as a rib type waveguide by, for example, etching the substrate other than the optical waveguide or forming grooves on both sides of the optical waveguide. The optical waveguide device of the present invention is particularly effective for a step-index (SI) type waveguide such as the rib type waveguide having a point of discontinuity where a refractive index discontinues, rather than a graded-index (GI) type optical waveguide such as a diffused waveguide.

As illustrated in FIGS. 8 and 9, the directional coupler used in the optical waveguide device of the present invention has a symmetrical structure about the traveling direction of the light wave. Thus, wavelength dependence of a branch ratio is suppressed. This is advantageous with respect to wavelength dependence of an ON/OFF extinction ratio which is an important characteristic for an optical modulator. While the configuration in FIGS. 8 and 9 has wavelength dependence of an optical loss, an unnecessary light beam does not radiate light outside the waveguide even in a case where a shift from an optimal wavelength occurs. For example, in a case where the configuration functions as a branching part in FIG. 8, the unnecessary light beam stays in the center waveguide CLG. Thus, leakage of the unnecessary light beam can be suppressed by terminating the optical waveguide in a rear stage of the center waveguide CLG as described later.

As illustrated in FIG. 8, the directional coupler used in the optical waveguide device of the present invention functions as a branching waveguide by introducing a light wave L1 from one side (a left side in FIG. 8) of the center waveguide CLG and deriving light waves L2 and L3 branching from the light wave L1 from two side waveguides (SLG1 and SLG2) positioned on the other side (a right side in FIG. 8) of the center waveguide CLG.

In addition, as illustrated in FIG. 9, the directional coupler functions as a combining waveguide by introducing two light waves (L4 and L5) from the one side (a left side in FIG. 9) of the two side waveguides (SLG1 and SLG2) and deriving a light wave L6 into which the two light waves (L4, L5) are combined from the center waveguide CLG positioned on the other side (a right side in FIG. 9) of the side waveguides.

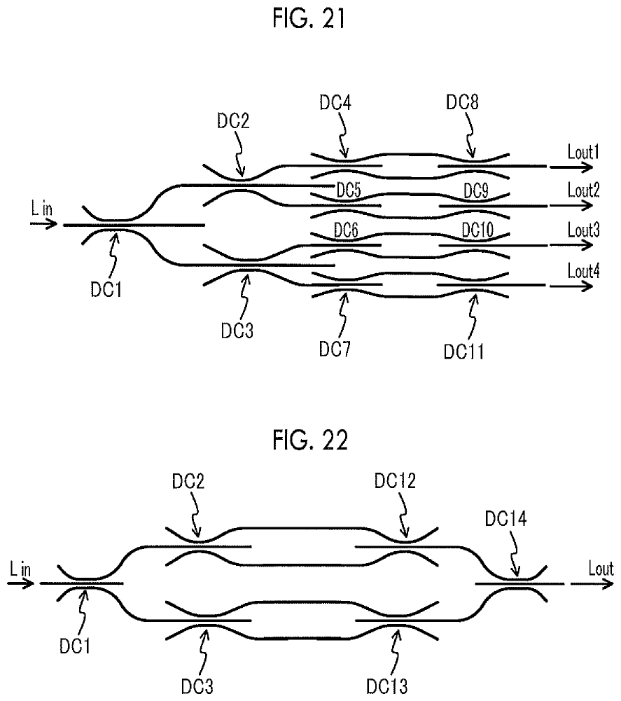

A Mach-Zehnder type optical waveguide as illustrated in FIG. 10 can be configured by combining two directional couplers. Furthermore, a plurality of Mach-Zehnder type optical waveguides disposed parallel to each other as illustrated in FIG. 21 or a nested form optical waveguide as illustrated in FIG. 22 can be configured by combining a larger number of directional couplers (DC1 to DC14). In FIG. 21, one beam of input light Lin branches into four, and four beams of output light (Lout1 to Lout4) are obtained by four Mach-Zehnder type optical waveguides. In FIG. 22, two Mach-Zehnder type optical waveguides are disposed in a nested form. The input light Lin branches into two, each branch light is input into the two Mach-Zehnder type optical waveguides, and the output light is combined into one to be output as a light wave Lout.

As described above, in the case of using the directional coupler as, for example, the branching waveguide, the unnecessary light beam is radiated from an end portion of the center waveguide. In addition, in the case of using the directional coupler as the combining waveguide, the unnecessary light beam is derived from end portions of the side waveguides. These unnecessary light beams are coupled to another optical waveguide to be superimposed on a light wave propagating through the optical waveguide, thereby causing deterioration of the extinction ratio. In the case of one Mach-Zehnder type optical waveguide in FIG. 10, there is a region closed by side waveguides SLG1 to SLG4 positioned on an outer side (in the directional coupler part, it is difficult for the unnecessary light beam to escape since the center waveguide and the side waveguides are close to each other; such a region surrounded by the optical waveguide is referred to as a “closed region”). In the case of the nested form waveguide as in FIG. 22, the number of parts where the unnecessary light beam occurs within the closed region is larger. Thus, an issue of removing the unnecessary light beam is a more important object.

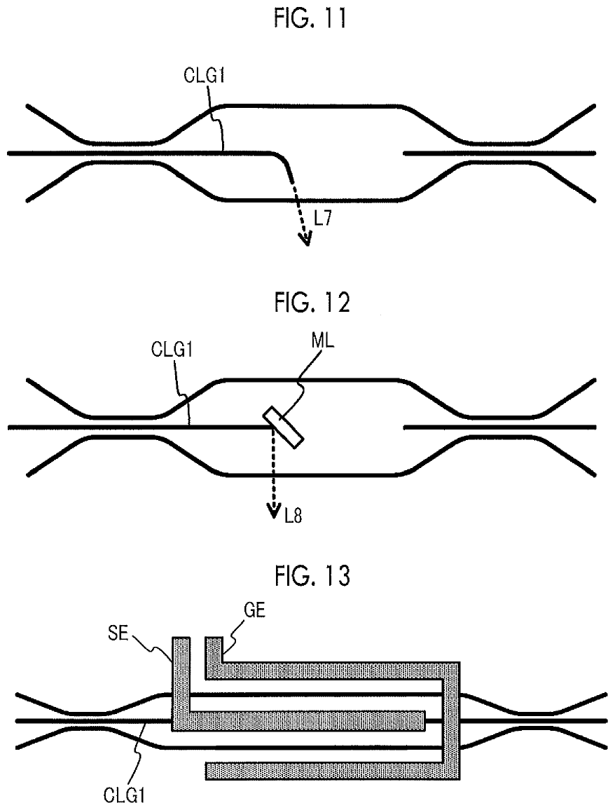

In FIG. 10, dotted line frames RM1 to RM3 illustrate unnecessary light beam removing units that remove the unnecessary light beams occurring in a center waveguide CLG1 and in the side waveguides (SLG3 and SLG4). In the directional coupler functioning as the combining waveguide, the unnecessary light beam is radiated from the end portions of the side waveguides. As a configuration of the unnecessary light beam removing units, as illustrated in FIG. 11, it is configured to bend a tip end of the waveguide (CLG1) to have an angle at which a radiating unnecessary light beam L7 is unlikely to be coupled to another optical waveguide. As a method of adjusting the radiation angle of the unnecessary light beam, as illustrated in FIG. 12, a reflective member ML can also be disposed in the end portion of the waveguide (CLG1) or close to the end portion to adjust a radiation angle of an unnecessary light beam L8. Various configurations such as a method of disposing a material having high reflectance or forming a side surface of a groove as a specular surface can be employed as the reflective member.

As another unnecessary light beam removing unit, the unnecessary light beam can also be absorbed to be removed. As a specific configuration, an optical absorption member such as a metal film is disposed at a position where the unnecessary light beam radiated from the top of the waveguide or from the end portion of the waveguide propagates. In FIG. 13, the end portion of the center waveguide CLG1 is disposed under a signal electrode SE of the optical modulator to absorb the unnecessary light beam radiated from the center waveguide via the signal electrode. The metal film that absorbs the unnecessary light beam is not limited to the signal electrode SE, and a ground electrode GE can also be used. In addition, another metal film can also be separately provided as the optical absorption member.

In FIG. 10, dot-dashed line frames GU1 to GU3 are unnecessary light beam blocking units for protecting, from the unnecessary light beam, a part where the input light is not introduced from the end portion in the center waveguide and the side waveguides constituting the directional coupler. Examples of a method of blocking the unnecessary light beam include a method of inclining the waveguide with respect to a propagation direction of the unnecessary light beam so that the unnecessary light beam is not coupled to the waveguide, a method of providing a unit that reflects the unnecessary light beam before the waveguide, and furthermore, a method of providing a unit that absorbs the unnecessary light beam.

In the directional coupler used in the optical waveguide device of the present invention, as a length of a coupling portion is decreased, the wavelength dependence is reduced. However, shortening the length of the coupling portion requires weakening optical confinement of the waveguide in the coupling portion. Of course, increasing optical coupling between waveguides in the coupling portion is also effective. For example, in the rib type waveguide that is manufactured by processing to form a groove on a substrate having a high dielectric constant (refractive index) such as LN, even in a case where it is difficult to decrease a clearance between the waveguides because of a manufacturing process, the wavelength dependence can be suppressed by shortening the coupling length by, for example, lowering a processing depth to reduce the level of difficulty in the manufacturing process while weakening the optical confinement.

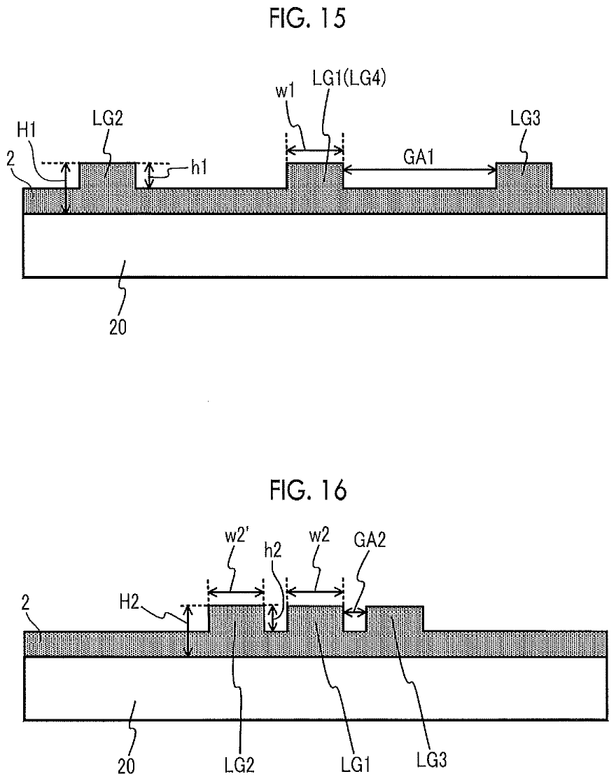

FIG. 14 is a Mach-Zehnder type optical waveguide configured with the directional coupler, and cross section shapes of each dotted line part are illustrated in FIG. 15 to FIG. 18. In FIG. 15 to FIG. 18, a thin film rib type optical waveguide using LN will be illustratively described.

FIG. 15 illustrates a cross sectional view taken along dotted lines A, D, and F in FIG. 14.

A LN layer 2 is formed on a support substrate 20 of si or the like. A film thickness H1 of the LN layer 2 is set to a few μm or lower, more preferably 1 μm or lower, and further preferably, for example, 0.5 μm or lower. A height h1 of the rib type waveguide is set to 1 μm or lower, more preferably 0.5 μm or lower, and further preferably, 0.25 μm or lower in other than a location where the center waveguide and the side waveguides of the directional coupler are close to each other. Generally, as the height h1 of the rib type waveguide is lowered, an intensity of optical confinement by the optical waveguide is weakened.

Regarding a width w1 of the optical waveguide, while the loss of the waveguide is also affected by the height of the rib type waveguide, the loss of the waveguide is generally increased as the width of the optical waveguide is narrowed. In addition, it is also required to consider the loss in a bending part of the optical waveguide. A bending loss depends on a size of a bending radius. In a case where a minimum bending radius of the bending waveguide is set to 100 μm to suppress a device size, the width w1 of the waveguide is desirably 0.6 μm or higher and 2.0 μm or lower.

In the directional coupler used in the optical waveguide device of the present invention, three waveguides are disposed in not only the coupling portion where the side waveguides are close to the center waveguide but also before and after the coupling portion. Particularly, by configuring a distance GA1 between a center waveguide LG1 (LG4) and side waveguides (LG2, LG3) to be twice or more of a mode diameter of the light wave propagating through the waveguide, the light wave can be continuously and stably guided to the coupling portion from a situation where each waveguide does not cause optical coupling, and an increase in a propagation loss and a change in the branch ratio or the like can be suppressed. Of course, even in a case where each waveguide is separated from the coupling portion, it is preferable that the distance between the waveguides continuously and stably changes to be finally up to twice or more of the mode diameter.

In dotted line B in FIG. 14, three optical waveguides constitute the coupling portion of the directional coupler. FIG. 16 illustrates a cross sectional view taken along dotted line B. In the coupling portion, the waveguides are separated from each other and are in a non-contact state. However, in order to facilitate occurrence of optical coupling, it is required to weaken the intensity of optical confinement of the individual waveguides. One method is setting a width w2 (w2′) of the optical waveguide in FIG. 16 to be narrower than the width w1 of the optical waveguide in FIG. 15. The width w2 of the center waveguide and the widths w2′ of the side waveguides in the coupling portion may be the same or different from each other.

In addition, as another method, the intensity of optical confinement can be weakened by setting a height h2 of the rib type waveguide in FIG. 16 to be lower than the height h1 in FIG. 15. However, excessively lowering the height h2 increases the loss of the bending waveguide before and after the coupling portion. In a case where the minimum bending radius of the bending waveguide is set to 100 μm, the processing depth h2 of the waveguide is desirably 30% or higher and 70% or lower of a substrate thickness H2 of a waveguide layer.

Of course, optical coupling between each waveguide can be further increased by narrowing a distance GA2 between the waveguides. The distance GA2 is preferably set to be less than twice the mode diameter of the light wave propagating through the waveguide (LG1 or LG2 (LG3)) and more preferably one times the mode diameter or less. However, in a case where it is difficult to narrow the distance between each waveguide because of processing accuracy, it is preferable to combine a method of, for example, narrowing the width w2 (w2′) of the waveguide or lowering the height h2 of the rib type waveguide. The height H2 of the LN film in FIG. 16 may be the same as the thickness H1 of the LN film in FIG. 15 or may be changed in accordance with the height of the rib type waveguide.

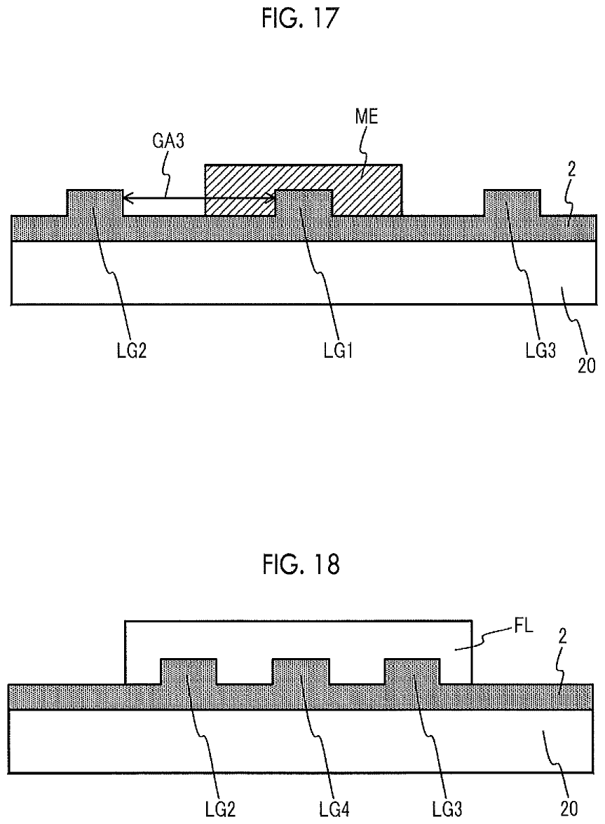

FIG. 17 illustrates a cross sectional view taken along dotted line C in FIG. 14. A metal film ME is disposed on an upper portion of the center waveguide LG1 and functions as the optical absorption member. In the case of disposing the metal film ME, it is important to not only focus on a distance GA3 between the center waveguide LG1 and the side waveguides (LG2 and LG3) but also consider sufficiently widening a distance between the metal film ME and the side waveguides so that the light waves propagating through the side waveguides are not absorbed by the metal film ME. For example, the distance between the metal film ME and the waveguide (side waveguides) is preferably set to be twice or more of the mode diameter of the light wave propagating through the waveguide.

Furthermore, there is also a method of changing a difference in the refractive index between a core portion constituting the optical waveguide and a clad portion around the core portion. Specifically, as illustrated in FIG. 18 which is a cross sectional view taken along dotted line E in FIG. 14, a covering of a material (resin, SiO₂, or the like) that has a lower refractive index than a material of the core and that is transparent with respect to transmitted light can be provided around the rib type waveguide to surround the rib type waveguide. In this case, refractive index contrast between the core and the clad is lower than that in a case where nothing (air) is provided in the upper clad (around the waveguide) as in FIG. 16. Thus, this acts to weaken the optical confinement. In addition, reduction of a light scattering loss caused by processing degradation and the like of a surface of the optical waveguide can also be expected. The upper clad may be disposed in only the coupling portion of the directional coupler or can also be provided on the entire optical waveguide to suppress the light scattering loss. In addition, an upper clad having a higher refractive index can also be used in only the coupling portion in order to increase an effect of strengthening coupling.

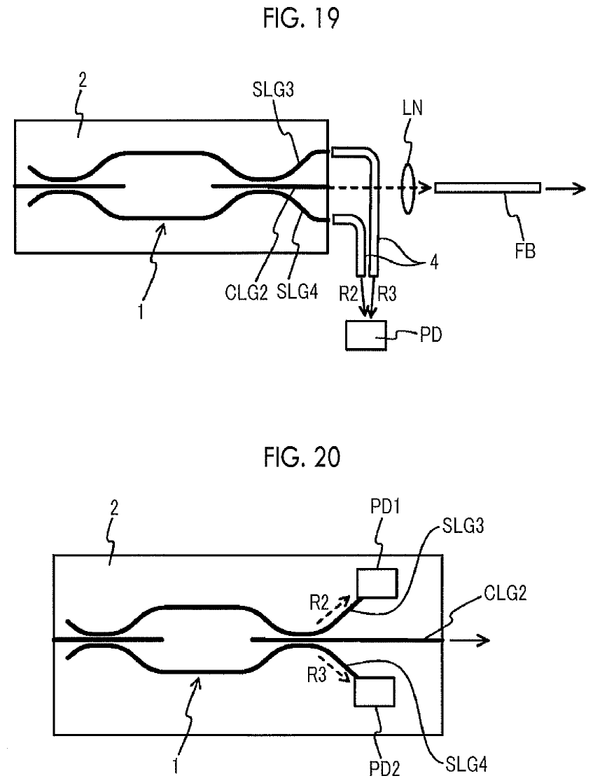

FIG. 19 and FIG. 20 describe the optical waveguide device in which the unnecessary light beam output from the directional coupler, particularly the unnecessary light beam (radiation mode light) radiated from the side waveguides (SLG3, SLG4) in a case where the directional coupler functions as the combining waveguide, is detected by a photo detection unit PD (PD1, PD2). A modulation state of the Mach-Zehnder-type waveguide can be monitored by receiving the unnecessary light beam. In a Y-branched waveguide and the like, light is radiated outside the waveguide during an OFF operation (in a case where both arms have opposite phases) of the modulator. However, in the present invention, light stays in the side waveguides and can also be extracted for the purpose of monitoring light and the like for control. Dividing the monitoring light into two to be output is also compatible with the technology in Japanese Laid-open Patent Publication No. 2012-173654 that can compensate for the difference in the phase.

As a guide unit that guides the unnecessary light beam (radiation mode light R2 and R3) to the photo detection unit, an optical fiber 4 is used in FIG. 19, and the side waveguides (SLG3, SLG4) are extended to configure the guide unit in FIG. 20. In addition, in FIG. 20, the photo detection units PD1 and PD2 are disposed on an upper surface of a substrate 2. While a lens LN and an optical fiber FB in FIG. 19 are illustrated for reference, configurations are not limited to the lens LN and the optical fiber FB.

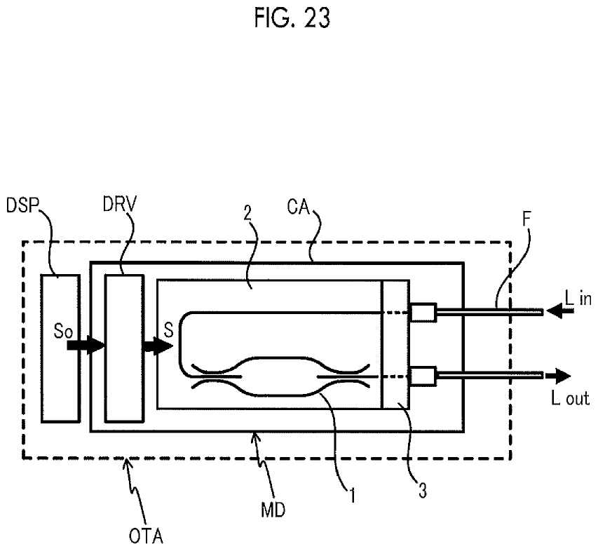

FIG. 23 is a diagram illustrating an example of an optical transmission apparatus. In recent years, an optical modulation device such as a high bandwidth-coherent driver modulator (HB-CDM) in which a driver IC and the optical waveguide device and the like are integrated in the same case has drawn attention, and there has been an increasing need for a configuration suitable for size reduction and the like, such as the optical waveguide device of the present invention.

In an optical modulation device of the present invention, the optical waveguide device is disposed inside a case CS of metal or the like. In the optical waveguide device inside the case, the input light Lin is input into an optical waveguide 1 formed on the optical waveguide device through an optical fiber F or other optical components such as a lens. Meanwhile, the light wave output from the optical waveguide device is input into another optical fiber F and results in the output light Lout. In outputting light, an optical component such as polarization combining means or a lens is used, as necessary. A modulation electrode, not illustrated, is formed on the substrate 2 of the optical waveguide device. In addition, a reinforcing member 3 for increasing mechanical strength is disposed on the substrate in input and output portions of the optical waveguide device, as necessary.

In the optical modulation device, a driver circuit element DRV that generates an electrical signal S to be applied to the modulation electrode of the optical waveguide device is disposed adjacent to the optical waveguide device, and the optical waveguide device and the driver circuit element DRV are accommodated inside the same case CS.

Furthermore, an optical transmission apparatus can also be configured by providing a signal generator DSP (digital signal processing device) that generates a modulation signal So to be input into the driver circuit element DRV. The case CS and the signal generator DSP can also be incorporated in one chassis.

As described above, according to the present invention, it is possible to provide an optical waveguide device that suppresses an optical loss of a light wave in a branching part and a Y-junction of an optical waveguide and that reduces deterioration of the optical loss and a branch ratio caused by wavelength dependence and leakage of an unnecessary light beam and furthermore, a level of difficulty in processing. Furthermore, it is possible to provide an optical modulation device and an optical transmission apparatus using the optical waveguide device.

What is claimed is:

1. An optical waveguide device comprising an optical waveguide formed on a substrate,
wherein a directional coupler is disposed in a part of the optical waveguide,
the directional coupler includes one center waveguide and two side waveguides disposed to interpose the center waveguide between the side waveguides,
the side waveguides are disposed to come close to the center waveguide from a position where the side waveguides are separated from the center waveguide and then to be separated again from the center waveguide in a traveling direction of a light wave, and
the center waveguide and the side waveguides are not in contact with each other.

2. The optical waveguide device according to claim 1,
wherein a distance between the center waveguide and the side waveguides before coming close to the center waveguide and a distance between the center waveguide and the side waveguides after being separated from the center waveguide are set to be twice or more of a mode diameter of a light wave propagating through the optical waveguide.

3. The optical waveguide device according to claim 1,
wherein an intensity of optical confinement of the optical waveguide in any of the center waveguide or the side waveguides is weaker in a state where the center waveguide and the side waveguides are close to each other than in a state where the center waveguide and the side waveguides are separated from each other.

4. The optical waveguide device according to claim 1,
wherein the directional coupler functions as a branching waveguide that introduces a light wave from one side of the center waveguide and that derives the light wave branching from the two side waveguides positioned on the other side of the center waveguide.

5. The optical waveguide device according to claim 4,
wherein an unnecessary light beam removing unit that causes a light wave propagating through the center waveguide to be absorbed or to be radiated outside the optical waveguide device is provided on an output side of the directional coupler.

6. The optical waveguide device according to claim 1,
wherein the directional coupler functions as a combining waveguide that introduces two light waves into each side waveguide from the one side of the two side waveguides and that derives a light wave into which the two light waves are combined from the center waveguide positioned on the other side of the side waveguides.

7. The optical waveguide device according to claim 6,
wherein an unnecessary light beam removing unit that causes a light wave propagating through the side waveguides to be absorbed or to be radiated outside the optical waveguide device is provided on an output side of the directional coupler.

8. The optical waveguide device according to claim 6,
wherein a guide unit that guides at least a part of a light wave propagating through the side waveguides to a photo detection unit is provided on an output side of the directional coupler.

9. The optical waveguide device according to claim 1,
wherein the optical waveguide includes a Mach-Zehnder type optical waveguide, and
the directional coupler is incorporated in at least one of a branching part or a Y-junction of the Mach-Zehnder type optical waveguide.

10. An optical modulation device comprising:
the optical waveguide device according to claim 1;
a case accommodating the optical waveguide device; and
an optical fiber through which a light wave is input into the optical waveguide or output from the optical waveguide.

11. The optical modulation device according to claim 10,
wherein the optical waveguide device includes a modulation electrode for modulating a light wave propagating through the optical waveguide, and
an electronic circuit that amplifies a modulation signal to be input into the modulation electrode of the optical waveguide device is provided inside the case.

12. An optical transmission apparatus comprising:
the optical modulation device according to claim 10; and
an electronic circuit that outputs a modulation signal causing the optical modulation device to perform a modulation operation.
